(19) United States
(12) Patent Application Publication
(10) Pub. No.: US 2021/0112635 A1
(43) Pub. Date: Apr. 15, 2021

(54) HEAT CONTROL SYSTEM

(71) Applicant: HCM, LTD., Denver, CO (US)

(72) Inventor: Joshua R. Taylor, Glenwood Springs, CO (US)

(73) Assignee: HCM, LTD., Denver, CO (US)

(21) Appl. No.: 17/066,937

(22) Filed: Oct. 9, 2020

Related U.S. Application Data
(60) Provisional application No. 62/915,055, filed on Oct. 15, 2019.
(60) Provisional application No. 62/981,948, filed on Feb. 26, 2020.
(60) Provisional application No. 62/988,498, filed on Mar. 12, 2020.

(51) Int. Cl. H05B 3/56; E04D 13/076; H05B 3/00; H05B 3/04

(52) U.S. Cl. CPC H05B 3/56; E04D 13/0762; H05B 2214/02; H05B 3/04; H05B 3/0019

(57) ABSTRACT

A heating wire control system has a normally open relay, a control circuit, and a remote controller. The control circuit has a transmitter/receiver adapted for wireless communication with a remote server and is adapted to obtain operational parameters from the remote controller through the server, and to use the operational parameters to selectively provide an electrical signal close the relay and energize heating wire. Weather forecasts, time, ambient conditions, and manual input are all selectively used by the control circuit to operate the control system.

### RELATED APPLICATION

This application claims priority to U.S. Provisional Applications Nos. 62/915055 filed on 15 Oct. 2019, 62/981948 filed on 26 Feb. 2020, and 62/988498 filed on 12 Mar. 2020, the teachings of which are all incorporated herein in their entireties by reference.

### FIELD OF THE INVENTION

This invention relates to controllers for heating systems including those used to thaw ice and snow from roofs and to controllers for serving similar functions in other applications.

### BACKGROUND OF THE INVENTION

Roof de-icing systems are well known and typically consist of heating wire or such that is attached along the lower portion of a pitched roof, valleys and down spouts and selectably energized to melt snow and ice and prevent the formation of ice dams. Various controllers exist for operating such roof de-icing systems. Such controllers typically include a thermostat to close a relay when the ambient outdoor temperature falls to a selected level to power the de-icer, or a timer to close such a relay according to a selected schedule. Some of such systems have a manual switch to override the temperature or time settings when desired and are often centrally located within a garage, closet etc.

There exists the need for a roof de-icing system controller with more versatility, that enables wireless remote control, that enables control from afar, that has WiFi connectability, that can cooperate with weather forecasts, and that is automated to enable additional parameters for operation beyond just ambient temperature and time. Addressing these needs and other improvements are objects of the present invention.

Other heating applications are in need of means for heating and for the control thereof, or for improved control of heating. For instance, aluminum benches such as those installed in many outdoor stadia and those used by athletes sitting on the sidelines are notoriously cold in the winter and could be greatly improved by a heating system which takes advantage of the thermal conductivity of the aluminum. Such a heating system could be controlled by the control system taught herein.

Further needs served by the invention may be appreciated upon review of the following teachings of exemplary embodiments thereof.

### SUMMARY OF THE INVENTION

The present invention is directed to a controller for such heating functions as roof de-icing systems having the ability to sense and react to temperature, humidity, and other parameters, having WiFi capabilities to allow for control from one or more smart phones or PC's whether distant or nearby, having the ability to access weather forecasts through the WiFi and automatically adjust its own operation according thereto, having the ability to be instructed by only selected individuals, having a manual operation option, and having an infinite number of scheduling options which may be over-ridden as needed and will resume thereafter. Programming is all accomplished from a simple software app available on smart devices.

The invention may be embodied within or practiced using a heating wire control system having a relay with an input terminal adapted for electrical connection to a power supply, an output terminal, and a signal terminal. The input and output terminals may normally be open-circuited and may be close-circuited during the receipt of an electrical signal to the signal terminal. The controller can serve as a stand-alone unit, only requiring; power, Wifi signal and a smart device for pairing & programming. It can also serve as a complete system, where “n” units sense and control heat tape circuits in various property locations and varying conditions.

The system may have a control circuit with a transmitter/receiver adapted for wireless communication with a remote server, an output signal connection to the signal terminal and adapted to selectively provide the electrical signal thereto, a connector in electrical communication with the output terminal and adapted to engage a heating wire, and a remote controller adapted for wireless communication with the transmitter/receiver through the remote server.

The control circuit may be adapted to obtain operational parameters from the remote controller through the server and the transmitter/receiver, and to use the operational parameters to selectively provide the electrical signal to the signal terminal so that the heating wire is energized there-during.

The heating wire control system may also have an ambient conditions sensor adapted to provide one or both of ambient temperature and humidity conditions to the control circuit, wherein the control circuit uses the one or both together with the operational parameters to selectively provide the electrical signal to the signal terminal so that the heating wire is energized there-during.

The heating wire control system may also have a timer adapted to provide time information to the control circuit, wherein the control circuit is adapted to use the time information together with the operational parameters to selectively provide the electrical signal to the signal terminal so that the heating wire is energized there-during.

The heating wire control system may also include an application program loadable into the remote controller and adapted to pair the remote controller with the control circuit, whereby non-paired remote controllers are denied wireless communication with the transmitter/receiver. The application program may validate user authorization, whereby non-authorized users are denied wireless communication with the transmitter/receiver.

The heating wire control system may also have one or more weatherproof housings enclosing the control circuit, relay, timer, and connector. The one or more housings may include a removable weatherproof cover to allow user access to the connector without disturbing the control circuit, relay, or timer. The one or more housings may include screw bosses through which screws affix the housing to a structure, and the screw bosses may be adapted to cause a cooling air space between the housings and the structure, additionally this will prevent the build-up of snow & ice surrounding the unit to prevent corrosion of the building structure The one or more housings may be made of a polymer which allows radio-magnetic frequencies to pass unimpeded.

Heat-tolerant silicone rubber gasketing may be disposed between the one or more housings and the removable weatherproof cover. The ambient sensor, power supply, and heating wire may enter the housing through liquid tight cord grips.

The invention may alternatively be embodied within or practiced using a heating control system having a normally open relay, a control circuit with a transmitter/receiver adapted for wireless communication with a remote server, and a remote controller adapted for wireless communication with the remote server. The control circuit may be adapted to obtain operational parameters from the remote controller through the remote server and to use the operational parameters to selectively provide an electrical signal to close the relay and energize a heater wire.

The server may provide access to weather forecast information and the control circuit may also include any combination of an ambient conditions sensor, a timer; and a manual input. Any combination of the weather forecast information, ambient conditions sensed by the ambient conditions sensor, time information provided by the timer, and instructions provided from the manual input may be used by the control circuit to operate the control system.

The invention is also able to control many other high-power devices such as drive motors, pumps, cooling systems, industrial processes, etc. and is novel in many such applications, building on the theme of high-power and other applications that the innovation could enable.

### BRIEF DESCRIPTION OF THE DRAWINGS

FIG. 1 is a top view of the heat control system a heat control system according to a first embodiment of the invention;

FIG. 2 is a top view of the heat control system of FIG. 1 with the module covers removed;

FIG. 3 is a perspective view of a typical house having the heat control system of FIG. 1 and roof heating wire installed thereon;

FIG. 4 is a wireless communications diagram for the heat control system of FIG. 1;

FIG. 5 is a perspective view of the heat control system according to a second embodiment of the invention;

FIG. 6 is an exploded perspective view of the heat control system of FIG. 5;

FIG. 7 is a circuit diagram for the heat control systems of FIGS. 1 and 5;

FIG. 8 is a top perspective view of a bench having the heat control system of FIG. 5 installed therein;

FIG. 9 is a bottom perspective view the bench and heating control system of FIG. 8; and

FIG. 10 is a circuit diagram for a heat control system according to a third embodiment of the invention.

### DETAILED DESCRIPTION OF THE INVENTION

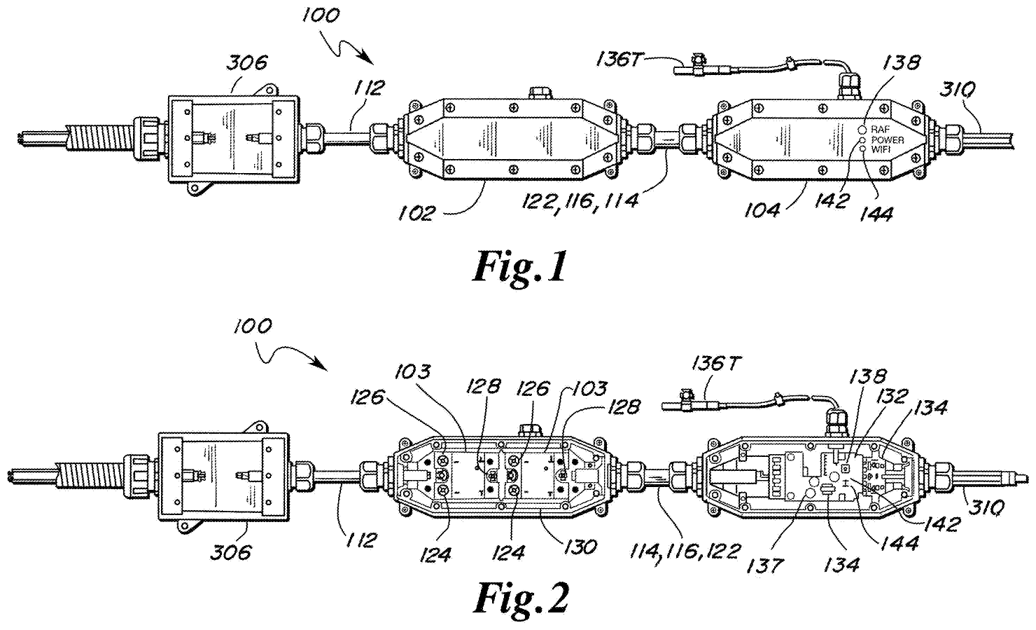

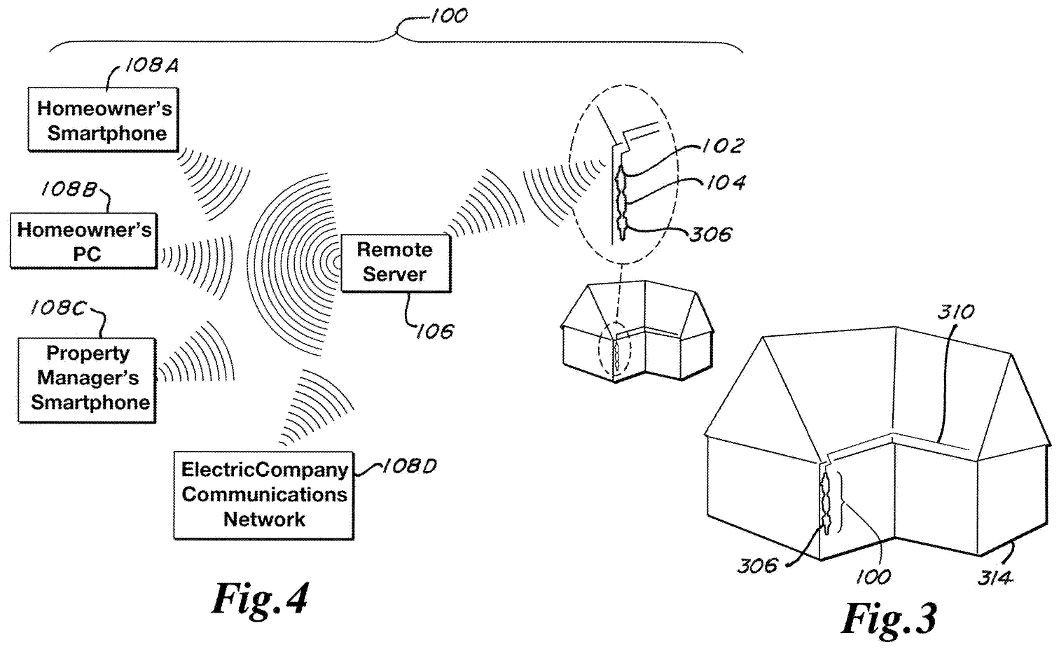

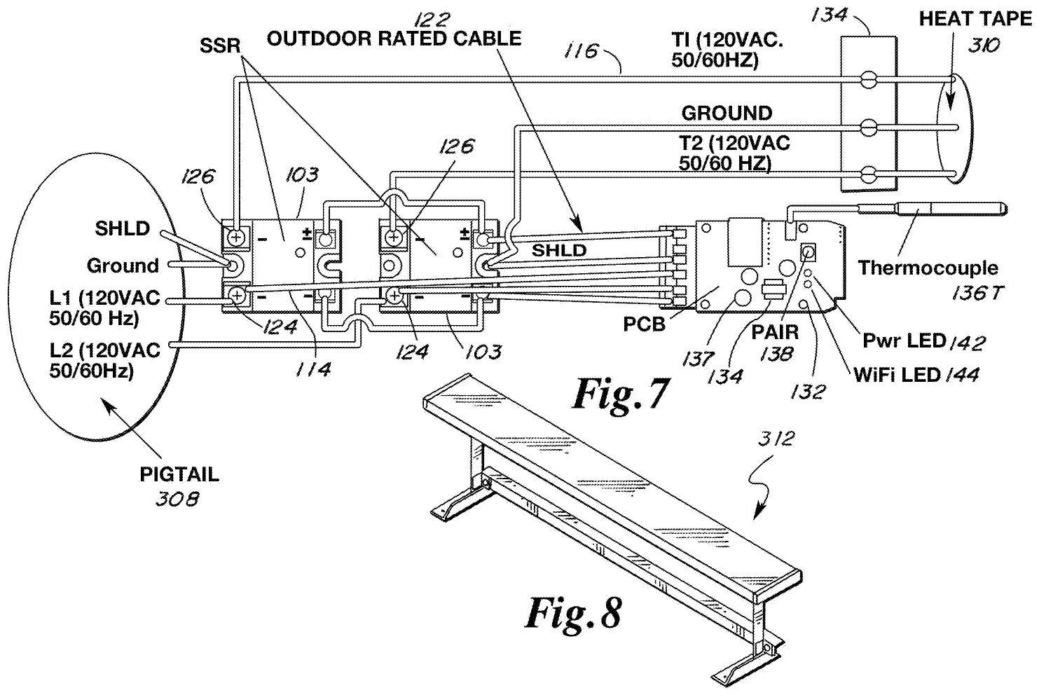

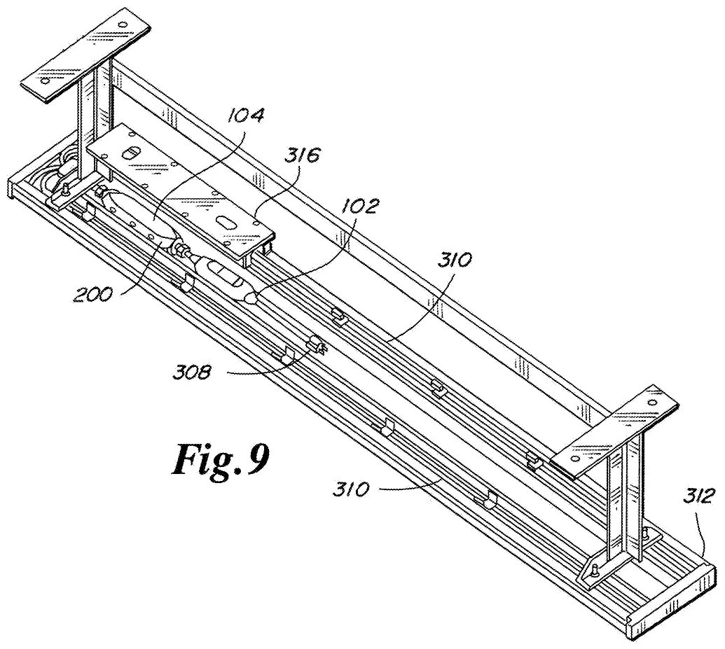

Exemplary heater control systems in accordance with or useful in practicing the invention are shown in FIGS. 1 through 9. The first system embodiment 100 of Figs through 4 and FIG. 7 is intended to be direct wired into a standard household junction box 306 of a structure such as a house 314, as shown in FIG. 3. The second system embodiment 200 of FIGS. 4, 5, and 7-9 is wired with a standard power supply plug 308 to be connected to a typical household 120 VAC or 240 VAC power supply outlet for uses such as those shown with a stadium bench in FIGS. 8 and 9. The two embodiments are otherwise identical and the following disclosure will otherwise apply equally to embodiments 100 and 200.

System 100 includes two modules; a relay module 102, a control module 104, and a remote server 106 and one or more remote-control devices 108A-108D. The system is powered by hard wiring from the electrical supply junction box and selectively powers a network of de-icing heating wire 310, and the control module communicates wirelessly through the remote server with one or more of the remote-control devices.

The relay module includes; Romex-type in-power cable 112 for hardwire connection to the electrical power supply (or in the case of the second embodiment for connection with a power supply plug), an electrical power feed 114 to the control module to provide power to the control board, a high-power electrical feed 116 to the control module to provide power for the de-icing network or a series of sub-networks, one or more solid-state power relays 118, and an electrical signal feed 122 from the control module to operate the relays.

The drawings show a relay module having two power relays 103, but it should be understood that any reasonable number of relays from 1 to X could be included according to the needs to the de-icing network. Two relays powering two separate portions of heating wire of a given length will produces less undesirable off-heating than a single relay powering the same given length. And while the embodiment shown are intended for 120 VAC operation, some roof heating wire is rated for 220 VAC, so two relays allow for use with such. When described herein, reference will often be made to “a” relay, but it should be understood that such reference applies similarly to each relay as needed.

Each relay includes an input terminal 124 connected to the power supply, an output terminal 126 connected to the high-power feed, and a signal terminal 128 connected to the signal feed. Any reasonable alternative to a solid-state power relay may be substituted, such as but not limited to a mechanical relay of a high-power transistor. A copper tray 130 is used in the exemplary embodiments both to better secure the relays to the housing and to as act as a heat sink to dissipate the undesirable off-heat they produce. As mentioned, the de-icing network may have more than one sub-network to serve different portions of the roof. Serving each sub-network from its own relay divides the power need through each relay to increase relay longevity and reduce damaging heating of the relays.

The control module includes; a printed circuit (PC) board 132 having thereon a WiFi transmitter/receiver 134, the electrical power feed 114 from the relay module connected to the printed circuit board, the signal feed 122 connected from the printed circuit board to the relay module's relay signal terminal, an electrical terminal block 134 connected to the high-power electrical feed 116 from the relay module's output terminal module, a thermocouple 136T connected to the PC board, a timer 137; a pair button/indicator 138 , a power indicator 142, and a WiFi indicator 144.

The printed circuit board has circuitry there-on including a WiFi transmitter/receiver adapted for wireless communication with the remote server and there-through to the remote-control device(s) by an encrypted application. The printed circuit board and terminal block are enclosed within the module's housing 104H, while the thermocouple is external and connected through the housing to the circuitry by wiring. The power and WiFi status indicators are visible and the pair button/indicator is visible and accessible on the module's removable housing cover 104C.

The roof de-icing heating wire network is connectable to the terminal block of the control module and the in-power cable is connected to the electrical power supply, providing low power to the control module and making high power available to the relay module. Using input from the remote-control via the remote server of input from the thermocouple, the circuitry sends signals to the relays to power the subnetworks as desired or needed. Only when a relay is closed by the control circuitry does it enable the electrical power from the supply to the associated roof de-icing sub-network.

The relays are normally open-circuited between the input and output terminals and are close-circuited when a signal is received at the signal terminal. When close-circuited, the relays enable transmission of the electrical power from the supply to the roof de-icing heating wire.

The electrical power feed 114 from the relay module to the control module provide power to the PC board, to enable the WiFi transmitter/receiver to send and receive operation instruction signals and other information needed to set up the system and to identify the users. When programmed or other commanded to do so, the PC board sends a signal through the signal feed to the relay's signal terminal causing the relay's input and output terminals to close-circuit.

The terminal block, has the same number of connections as there are relays, and each is connected to the high-power electrical feed from the associated output terminal of the relay module's relays, and each is connectable to a separate sub-network of the de-icing network.

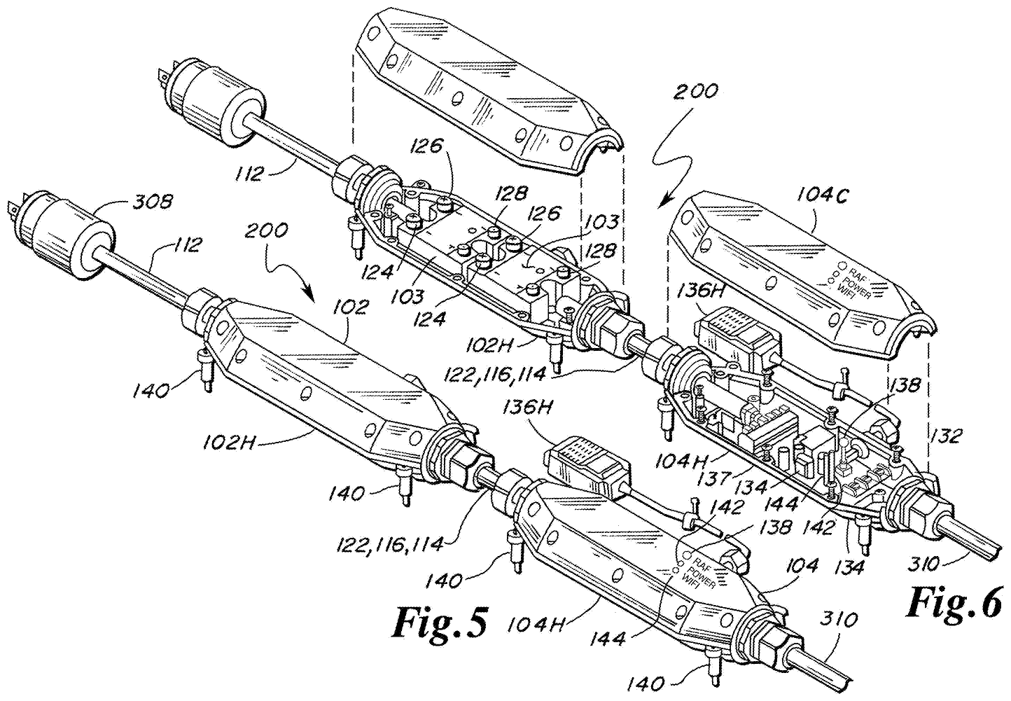

The ambient conditions sensor may be a thermocouple 136T as shown in the embodiment of FIGS. 1 and 2, may be a humidity sensor, or may be a combination thermocouple and humidity sensor 136H as shown in FIGS. 5 and 6. The sensor is connected to the PC board and provides indication of the ambient temperature and/or humidity, which may be used by the PC board to determine when to send a signal to the relay(s). An advantage to the system is that the average daily ambient conditions may be monitored and used to adjust the operations rather than just the instantaneous conditions. For instance, some areas will experience very cold nights and warm days which, on average, do not require operation of the de-icing system. But traditional temperature-sensing systems would activate the heating wire through the night. The intelligence and forecast-accessing of this system allows it to “know” that the average temperature will be high enough to melt the ice without any electrical consumption.

The pair button/indicator is a lighted switch mounted on the PC board and activatable from external of the control module that the user activates during the WiFi pairing of the control module with a selected one of the remote controls, and that lights up in various modes of continuous or blinking illumination to indicate the status of certain pairing functions of the controller. The power and WiFi indicators are LED's mounted on the PC board and visible from external of the control module through translucent lenses. The power indicator illuminates when the relays are close-circuited to indicate that the terminal block and any heating wire connected thereto are energized. The WiFi indicator lights up in various modes of continuous or blinking illumination to indicate the status of the wireless communication with the remote server. The pair button/indicator and the power and WiFi indicators are viewable and engageable by the user without removing the housing cover.

The relay and control modules are housed separately to allow adaptability, improve serviceability, simplify module replacement, simplify upgrading, and to increase radiational cooling of the adverse off-heating of the modules, but could be combined into a single housing including the functions of both modules.

As mentioned, the de-icing network may have more than one sub-network to serve different portions of the roof. Serving each sub-network from its own relay divides the power need through each relay to increase relay longevity and reduce damaging heating of the relays.

The control module 102 has an onboard relay that is rated to 15 amps steady state through which the signal s sent. This enabled the signal to be up to 15 amps which is sufficient to energize the heating wire without the relay module 104 for short (low power) lengths of heating wire. This is because lengths below say forty feet cause low enough inrush currents (commonly associated with heating wire) for the onboard relay to provide. The control module in combination with the relay module as disclosed herein extends the range to up to two-hundred and forty feet of heating wire, which is required for most roof de-icing applications.

The module housings are weatherproof and weatherproof except that the ambient conditions sensor is sensitive to moisture and ice and should be mounted where there is protection from the elements, but where a true reading can be made of the ambient temperature and humidity conditions.

The module housings are tested & listed as approved for outdoor electrical enclosures by Underwriters Laboratories. The module housings are made of plastic, preferably glass-filled polycarbonate, for electrical insulation, UV resistance, impact resistance, and to prevent RF interference as could be caused by housings made of metal. Gaskets and seals are preferably of silicone rubber. Wiring entryways, strain-reliefs, and indicators/buttons are all weatherproof. Heyco M320l liquid tight cord grips are used with custom silicone glands to provide both heat tolerance and optimal weatherproofing.

The cover of the control module must be removed by the user to connect the de-icing sub-networks to the terminal block, but the silicone gasketing ensures that reapplying the cover is simple and that the system remains weatherproof. The cover can be removed and replaced without disconnecting any of the other electrical components. A perimeter pocket accommodates the continuous gasket which can either be made by waterjet from R10480 silicone sponge sheets with pressure sensitive adhesive (PSA) or compression molded from solid Midgold GF852 silicone which is then glued into the cover using a Permatex clear RTV silicone adhesive sealant.

While not limited thereto, the modules of the exemplary embodiment shown herein are each 1.5″×3.75″×10.5″. This is valuable especially when the controller is to be used in conjunction with heating stadium seats as later explained.

The control module has three access ports, one for input power from a 14/2 Romex cable surrounded by ½″ plastic conduit or an outdoor rated pigtail cable one for a commercial off the shelf weatherproof thermocouple and the last for the exit of heat cable of several variants including; cross-section geometry (round . . . oval), heat flux (5 W/ft . . . 12 W/ft), dimensions (small . . . large) etc. The custom glands on the output accommodate many of the popular cables. The relay module uses the same housing except that the thermocouple access port is plugged. The module housings have access points for rigidly mounted terminal block screws (neutral, ground and load) on each end. The printed circuit board is a commercial off the shelf WiFi/16A relay controlled printed circuit board.

The module housings are cylindrically-shaped with flat top and bottom surfaces and tapered ends for both aesthetic and water shedding purposes. The polycarbonate glass fill thermoplastic resin allows the necessary radio-magnetic frequencies to pass unimpeded with minimal attenuation all the while offering a robust design to withstand the most extreme environmental conditions including temporary submersion. The module housings are affixed to a building by screws through screw bosses 140 which extend from the bottom of the housing to maintain a cooling gap & mitigate debris accumulation between the housings and the building.

After installing the controller and de-icing network and connecting it to the power supply, the user downloads a dedicated application (app) to his remote-control device, such as a smartphone, tablet, or PC. The app must be downloaded and installed to each remote device, not only those of the homeowner but also those of others who will have authority to control the de-icing system. For instance, the homeowner may have a property manager or neighbor whom he wishes to be able to control the system in his absence. Or the electrical power supplying company may require control to prevent operation during peak demand times.

The app leads the user through the following steps for registering the device and user, pairing the control module to the remote-control device, naming the de-icing network, and setting up de-icing parameters... conditions and/or times when the de-icing network should be energized;
1. Turn on the source power and ensure that the WiFi (blue) LED is illuminated. Then using your smart phone linked to the 2.4 GHz signal begins the pairing process.
2. Press and hold the pairing button for seven (7) seconds until the WiFi LED blinks three (3) times then on repeatedly.
3. Follow instructions for pairing the device.
4. Input your WiFi SSID & Password when prompted.
5. Name the device.
6. When the WiFi LED is on and no longer blinking, the device is paired and ready for use.
7. Attach cover with the inner boss covering the LED's.
8. Auto Mode: Parameters can be set so that the unit will switch on/off based upon temperature or humidity ranges as well as programmed scheduling.
9. Manual Mode: Temperature and humidity can also be monitored real-time from the unit and switched on/off from your smart phone remotely. The pairing button also acts as a manual switch by pressing once.

The system is compatible with Amazon Echo, Google Home and Google Nest. Scan the user guide for more information. A unique aspect of the system is that it can be programmed to access weather forecasting services through the internet and adjust operation according thereto. For instance, the controller might be programmed to normally energize the network for a couple of hours each evening for routine maintenance to keep ice and snow accumulation limited, or may be programmed to only operate below a certain temperature or within certain humidity conditions, but a forecasted incoming storm may cause the controller to override that programming energize the de-icing network several hours ahead of the storm to thereby lessen the burden on the system once the storm arrives, or in case the storm causes a power outage. Or the forecast may indicate a stretch of warm weather indicating that winter is ending and de-icing can be automatically terminated.

And the controller might recognize that power had been lost for an extended period and therefore cause an extended energization of the system, overriding the program once power is restored.

Although the primary intended use of the controller is in conjunction with roof de-icing systems, it is also anticipated that it could be used with such other heating requirements as heating water, oil and gas lines, heating livestock water tanks, heating aluminum team/spectator benches for the outdoor athletics industry, energizing Christmas lighting, etc. Many other heating applications are in need of means for heating and for the control thereof, or for improved control of heating. Such a control system as herein disclosed is uniquely adapted to enable some otherwise impractical heating functions.

For instance, with reference to FIG. 7, an aluminum bench 312 is shown typical of those installed in many outdoor stadia and those used by athletes sitting on the sidelines during outdoor games. Such benches get notoriously cold in the winter and could be greatly improved by a heating system which takes advantage of the thermal conductivity of the aluminum. FIG. 8 shows the plug-terminated second embodiment 200 of the heat control system and heating wire installed into the underside of the bench. The seat portions of such benches are typically approximately 12″ wide and made of extruded aluminum with a strengthening channel extruded into the underside that is typically 4″ wide by 3″ deep. The control system can fit perfectly within that channel and the heating wire can be fastened within the adjacent outer channels against the underside of the seat in thermal communication therewith as shown in FIG. 8. Cover 316 (shown removed) affixes to the underside to protect the controller. The entire stadium may then be controlled wirelessly and with a single program or command. And the sideline benches may all be controlled simultaneously with the same or an independent program or command.

Swimming pools at vacation homes could be programmed to start heating up automatically say for instance every Friday afternoon so that the pool is already warm when the homeowner arrives on Friday evening. Or the homeowner could remotely activate the heater from his smart phone as he is leaving his primary home.

Dock de-icing systems could be controlled by the system to increase cycle time as the ambient weather cools and/or to ramp up cycle time as the middle of winter waxes and ramp down cycle time as the winter wanes. Access to online weather information could allow the system to automatically shut down as ice-out conditions are arriving without any direct involvement from the user. An infinite number of additional applications may benefit or become possible from the features of the heat control system.

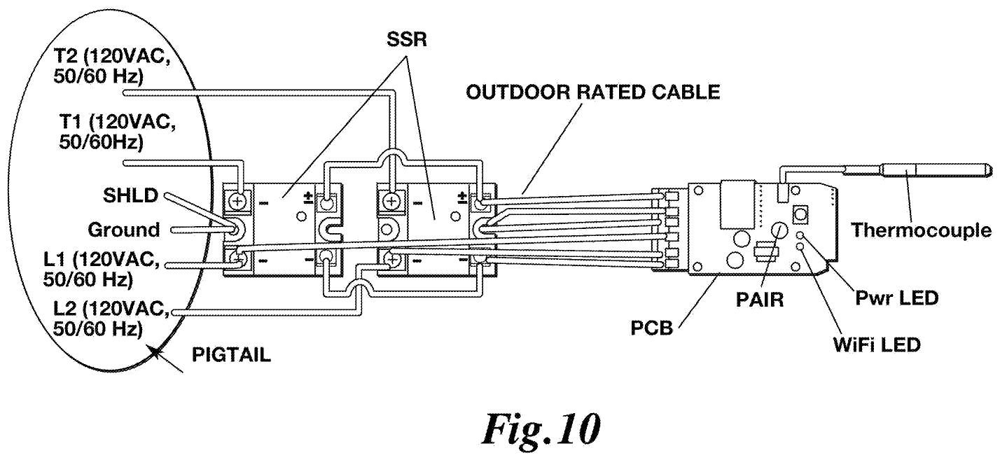

The first and second systems, 100 and 200, are designed for “through” applications in which the power input enters one end of the controller and the heating wire exits for the other end. FIG. 10 shows the wiring diagram for a third embodiment in which the input power enters and the heating wire exits form the same end . . . referred to as an “In and Out” arrangement.

The system provides interconnectivity which can accommodate various geometries and sizes . . . for instance; extension cords, spliced connections, and various heat tape sizes and shapes.

While the invention has been shown and described with reference to specific exemplary embodiments, it should be understood by those skilled in the art that various changes in form and detail may be made without departing from the spirit and scope of the invention, and that the invention should therefore only be limited according to the following claims, including all equivalent interpretation to which they are entitled.

I claim:

1. A heating wire control system comprising;
a relay having an input terminal adapted for electrical connection to a power supply, an output terminal, and a signal terminal, wherein the input and output terminals are normally open-circuited and are close-circuited during the receipt of an electrical signal to the signal terminal;
a control circuit comprising;
a transmitter/receiver adapted for wireless communication with a remote server;
an output signal connection to the signal terminal and adapted to selectively provide the electrical signal thereto;
a connector in electrical communication with the output terminal and adapted to engage a heating wire; and
a remote controller adapted for wireless communication with the transmitter/receiver through the remote server;
wherein the control circuit is adapted to obtain operational parameters from the remote controller through the server and the transmitter/receiver, and to use the operational parameters to selectively provide the electrical signal to the signal terminal so that the heating wire is energized there-during.

2. The heating wire control system of claim 1 further comprising an ambient conditions sensor adapted to provide one or both of ambient temperature and humidity conditions to the control circuit and wherein the control circuit is adapted to use the one or both together with the operational parameters to selectively provide the electrical signal to the signal terminal so that the heating wire is energized there-during.

3. The heating wire control system of claim 2 further comprising a timer adapted to provide time information to the control circuit and wherein the control circuit is adapted to use the time information together with the operational parameters to selectively provide the electrical signal to the signal terminal so that the heating wire is energized there-during.

4. The heating wire control system of claim 1 further comprising a timer adapted to provide time information to the control circuit and wherein the control circuit is adapted to use the time information together with the operational parameters to selectively provide the electrical signal to the signal terminal so that the heating wire is energized there-during.

5. The heating wire control system of claim 3 further comprising an application program loadable into the remote controller and adapted to pair the remote controller with the control circuit, whereby non-paired remote controllers are denied wireless communication with the transmitter/receiver.

6. The heating wire control system of claim 5 wherein the application program is adapted to validate user authorization, whereby non-authorized users are denied wireless communication with the transmitter/receiver.

7. The heating wire control system of claim 3 further comprising an application program loadable into the remote controller and adapted to validate user authorization, whereby non-authorized users are denied wireless communication with the transmitter/receiver.

8. The heating wire control system of claim 7 further comprising one or more weatherproof housings enclosing the control circuit, relay, timer, and connector.

9. The heating wire control system of claim 8 wherein the one or more housings comprise a removable weatherproof cover to allow user access to the connector without disturbing the control circuit, relay, or timer.

10. The heating wire control system of claim 9 wherein the one or more housings comprise screw bosses through which screws affix the housing to a structure, and wherein the screw bosses are adapted to cause a cooling air space between the housings and the structure.

11. The heating wire control system of claim 10 wherein the one or more housings are made of a polymer which allows radio-magnetic frequencies to pass unimpeded.

12. The heating wire control system of claim 11 further comprising a heat-tolerant silicone rubber gasketing disposed between the one or more housings and the removable weatherproof cover.

13. The heating wire control system of claim 12 wherein the ambient sensor, power supply, and heating wire enter the housing through liquid tight cord grips.

14. A heating control system comprising
a normally open relay;
a control circuit having a transmitter/receiver adapted for wireless communication with a remote server; and
a remote controller adapted for wireless communication with the remote server;
wherein the control circuit is adapted to obtain operational parameters from the remote controller through the remote server and to use the operational parameters to selectively provide an electrical signal to close the relay and energize a heater wire.

15. The heating control system of claim 14 wherein the server provides access to weather forecast information and the weather forecast information is used by the control circuit to operate the control system.

16. The heating control system of claim 14 wherein the control circuit further comprises an ambient conditions sensor and ambient conditions sensed thereby are used by the control circuit to operate the control system.

17. The heating control system of claim 14 wherein the control circuit further comprises a timer and time information provided therefrom is used by the control circuit to operate the control system.

18. The heating control system of claim 14 wherein the control circuit further comprises a manual input and instructions provided therefrom are used by the control circuit to operate the control system.

19. The heating control system of claim 14 wherein the server provides access for weather forecast information and the control circuit further comprises an ambient conditions sensor, a timer; and a manual input; and
wherein one or more of the weather forecast information, ambient conditions sensed by the ambient conditions sensor, time information provided by the timer, and instructions provided from the manual input are used by the control circuit to operate the control system.
